(19) United States
(12) Patent Application Publication
(10) Pub. No.: US 2002/0051804 A1
(43) Pub. Date: May 2, 2002

(54) Pesticides made from hop extracts

(76) Inventors: Gene Probasco, Yakima, WA (US); Mark M. Bossert, Yakima, WA (US); David W. Hysert, Yakima, WA (US)

Correspondence Address: BRUCE A. KASER, DAVIS WRIGHT TREMAINE LLP, 2600 CENTURY SQUARE, 1501 FOURTH AVENUE, SEATTLE, WA, 98101-1688, US

(21) Appl. No.: 09/573,332

(22) Filed: May 18, 2000

(51) Int. Cl. A01N 47/10; A01N 37/00; A01N 25/00; A01N 25/32; C12C 3/00; A01N 35/00; A01N 65/00

(52) U.S. Cl. 424/405; 424/406; 424/750; 514/557; 514/558; 514/689; 504/157; 504/171; 504/320; 426/600

(57) ABSTRACT

The invention is organic pesticides made from components of hop extract by preparing stable aqueous emulsions of hop acids and other hop extract components. The hop acids and other hop extract components are suspended as stable, colloidal preparations in water, which can be sprayed directly on plants for pest control.

### TECHNICAL FIELD

The invention disclosed here generally relates to pesticides. More particularly, it relates to the use of components of hop extracts as pesticides.

### BACKGROUND INFORMATION

Chemical pesticides are used in commercial agriculture, home gardening, residential use, and similar applications for the purpose of controlling insects and spiders. There are well known environmental and health concerns associated with using chemical pesticides. In some instances, it has been proven that the long-term use of certain chemical pesticides creates environmental problems. A well known example involves the ban of DDT in the United States.

Ongoing health concerns about chemical pesticides have given rise to an emerging market for “organic” pesticides. Insecticidal soap is a typical example of an organic pesticide in use today.

Organic pesticides are generally deemed to be less effective than chemical pesticides. There is a trade-off when comparing one to the other. Chemical pesticides have a higher level of toxicity and provide better pest control. However, higher toxicity also heightens environmental concerns. The same level of environmental concern does not attach to organic pesticides, but at the price of effective pest control.

Hop cones contain lupulin glands that have two important bittering substances: alpha acids and beta acids. These acids are sometimes called humulones and lupulones, respectively. Hop acids were initially used as a preservative agent for beer prior to the existence of refrigeration. Today, they are primarily used to create the bitter taste and flavor of beer.

The term “hop acids,” as used here, means alpha acids, beta acids, mixtures of these acids, and/or other components found in hop extracts, for example, beta fraction, essential oils, waxes, and uncharacterized resins. The term “hop acids” also includes all forms of modified hop acids, for example, iso-alpha acids, tetra-hydro-iso-alpha acids, rho-iso-alpha acids, hexa-hydro-iso-alpha acids, and hexa-hydro-beta-acids. As is well known, alpha acids consist of mixtures of analogues, primarily humulone, cohumulone, adhumulone, and other minor constituents. Similarly, beta acids consist of mixtures of analogues, primarily lupulone, colupulone, adlupulone, and other minor constituents. For these reasons, alpha and beta acids are referred to in the plural.

A number of companies are in the business of producing hop extracts for the brewing industry. These extracts come from the hops that are grown in various regions of the world. In some respects, the hop extract industry is a combination of agriculture and chemistry. On the agricultural side, hop growers have many of the same kinds of problems with pests as the growers of other food products. For example, spider mites, which are a common agricultural pest, are also a problem for hop growers.

Given that people have been drinking hop acids as part of beer for many centuries, hop acids are a proven organic consumable. Hops are one of the basic ingredients of beer and as such, hops and hop extracts are considered GRAS (Generally Recognized As Safe by the U.S. Food and Drug Administration (“FDA”).

Those who work with hop extracts recently discovered that the beta fraction of hop acids dissolved in ethanol or xylene can be toxic to spider mites. Hop acids and other components of hop extracts are not highly soluble in water but are quite soluble in nonaqueous solvents like ethanol and xylene. However, such nonaqueous solvents are undesirable carriers for the application of pesticides to plants.

Water is an essential carrier for pesticide application to plants. Because they are weak organic acids, the hop acids can be dissolved in water if the pH is raised and maintained above their pKa levels. The pKa's of the hop acids range from 5-9. Therefore, aqueous solutions of the hop acids can be produced at pH's ranging from 7-11 and higher. In contrast, the pH of chemical sprays is generally below 7. If the pH of a chemical spray is considerably higher than 7 or lower than 5, it raises concerns about its effectiveness when the spray is applied to plants.

If hop acids are to be used effectively as organic pesticides, they must be applied by using a non-toxic carrier for the pesticide. The present invention solves that problem.

### SUMMARY OF THE INVENTION

The invention is pesticides made from hop acids and other extract components. The pesticides are made by creating aqueous emulsions of hop acids. As will be explained below, an “emulsion” is different from a solution and enables hop acids and other hop extract components to be applied to plants as part of a water-based spray rather than using a nonaqueous solvent.

As mentioned above, hop acids are not highly soluble in water. However, stable aqueous solutions of certain hop acids can be prepared by the selection of appropriate concentration and pH. Further, it is possible to prepare aqueous emulsions of other hop extract components (for example, beta fraction and oils) that are stable, colloidal suspensions of hop extract components in water that will not separate over time. Both the solutions and the emulsions can be diluted with water as required by the end user for spraying. These dilutions produce stable aqueous emulsions in all cases at all dilutions.

The inventors have prepared three formulations of hop acids for use as pesticides. The first is a 10% beta-acids solution that can be diluted with water to any degree to produce stable aqueous emulsions. These resulting emulsions can be used as stable, water-based sprays. The second formulation consisted of a 10% alpha-acids solution diluted with water in the same way to produce stable aqueous emulsions. The third formulation was a stable aqueous solution of 10% beta fraction that can be diluted with water in the same way. These formulations were found to be highly effective when treating pest mites.

The manner and method for making the above formulations is described below.

### BEST MODE FOR CARRYING OUT THE INVENTION

The invention provides stable 10% solutions of hop acids or stable 10% emulsions of other hop extract components that can be diluted with water to the desired degree to produce stable aqueous emulsions that can be used as spray-on pesticides. The diluted emulsions remain stable at all dilutions. This means that concentrated solutions and/or emulsions can be sold as organic pesticides and later diluted by the user.

We have developed three basic formulations to date. The first formulation is a 10% emulsion of beta fraction. This emulsion can be diluted with water to any degree to form further stable emulsions. The second and third formulations involve the preparation of 10% solutions of alpha and beta acids. These aqueous solutions convert to stable, aqueous emulsions upon the addition of water. These formulations are set forth below:

### Preparation of 10% Emulsion of Beta Fraction (Beta Acid Oil) for Pest Control

The term “beta fraction” refers to the oily, waxy, resinous portion of the hop extract obtained when the hop extract is washed with caustic water to remove most of the alpha acids. The beta fraction contains mostly beta acids, resins, oils, and waxes; it is also called beta acid oil.

To prepare an aqueous emulsion of beta fraction, the beta fraction was heated to 60° C., and added to a volume of 60° C. water, to which an emulsifier, such as Ninol FM Tri-Emulsifier was added. Ninol FM Tri-Emulsifier is available from Northwest Agricultural Products, 821 S Chestnut, Pasco, Wash. 99302 (1-509-547-8234). The mixture was then emulsified in a high shear mixer to produce a stable emulsion.

Example

To produce ˜1 Kg of beta fraction emulsion, 100 g of beta fraction was heated to 60° C., and 890 grams of water was heated separately to 60° C. The warm beta fraction and water were mixed together, and 10 grams of Ninol emulsifier was added to the mixture (the addition of as little as 0.2% emulsifier will produce a stable emulsion; adding up to 2% emulsifier will increase beta fraction utilization). This mixture was placed in a high shear mixer (a Warring kitchen blender on high speed), mixed for 60-90 seconds, poured into a container, and let sit for 2-3 minutes or until any foam collapsed. Any of the beta fraction that would not emulsify was separated. The aqueous emulsion was decanted, and any beta fraction or foam that did not go into the aqueous emulsion was discarded.

A 10% beta fraction aqueous emulsion prepared as described in the above example is a stable emulsion. It has the property that when diluted with tap water or well water, it forms similarly stable aqueous emulsions at all dilutions.

### Preparation of 10% Aqueous Beta-Acids Solution for Pest Control

Beta fraction was the starting material used to prepare a 10% aqueous beta-acids solution. The beta fraction may be used as is or washed with caustic water to reduce the alpha-acids concentration in the beta fraction so that the ratio of alpha-acids to beta-acids is 0.05, or below, by HPLC analysis. The temperature of the beta fraction was raised to 60° C. with continuous mixing, and caustic was added in the form of KOH to bring the pH to 10-11. Having first determined the beta-acids content in the beta fraction by HPLC analysis, a volume of 60° C. water was added, while mixing, so that the beta-acids concentration of the aqueous phase was between 10% and 50%. The pH of the solution was adjusted, if necessary, to 10-11 at 60° C. It was necessary to subtract the volume of KOH added for pH adjustment from the calculated volume of water. Also, a temperature range of 55-70° C. was acceptable, although 60° C. was optimal. Mixing was stopped, and the mixture was allowed to sit for at least 45 minutes, during which time the temperature of the solution was maintained at 60° C. The aqueous beta-acids phase was then separated from the resinous phase. The aqueous phase was diluted to a concentration of 10% beta acids by HPLC, while the temperature was maintained at 60° C., and the pH kept at 10-11. The aqueous phase was cooled (mixing is optional) to 1-13° C., and allowed to sit for at least 2 hours. The solution was then decanted or filtered.

Example

500 g of beta fraction containing 50% beta-acids by HPLC was heated to 60° C. Approximately 250 mL of 20% KOH was added while stirring, with heat to maintain a 60° C. temperature, and to bring the pH up to 10.7. Mixing was stopped, and the mixture was allowed to sit overnight. The following morning, the resinous fraction was set aside and the aqueous fraction was heated to 60° C. and analyzed by HPLC. Water and 20% KOH were added to bring the beta acids concentration to 10%, and the pH to 10.7. The aqueous beta acids solution was refrigerated to 5° C. overnight, and filtered the next morning.

Example

1000 kg of beta fraction at 60° C. was placed in a hot water-jacketed tank. Approximately 120 gallons of 20% KOH was added with continuous mixing until the pH of the aqueous phase reached 10.7. The mixing was shut down, but the heat was maintained at 60° C., and the mixture was allowed to sit overnight. The aqueous layer was pumped into a stainless steel, heat-jacketed tank and diluted to a 10% beta-acids concentration by HPLC using deionized water. The temperature and pH were maintained at 60° C. and 10.7, respectively. Heating of the tank was stopped, the product was cooled to 10° C., and allowed to settle overnight. Clouded and precipitated material was pumped to a recycle tank, and the clear beta-acids solution was filtered.

10% beta-acids solution is relatively easy to make (see above examples) and is a clear solution with no precipitated material. It is similar in color, clarity, and consistency to weak iced tea. The stability is not robust, however. A change in temperature can cause cloudiness to appear. Also, if it is diluted with cold (or even warm) water after it is formulated, it becomes cloudy immediately.

Dilution of 10% beta-acids solution with tap water or well water results in the formation of a stable aqueous emulsion. It has the appearance of milk and does not exhibit any separation even during days of storage. It was very stable, and no precipitate formed, even down to a dilution of 1:16. Also, as the solution was diluted with water, only a minor change in the pH occurred. It dropped by about 0.5 pH units, certainly not enough to be the cause of the precipitation. No difference was observed when 0.4% Ninol emulsifier was added.

### Preparation of 10% Aqueous Alpha-Acids Solution for Pest Control

Supercritical CO₂ Nugget extract was used to prepare 10% aqueous alpha-acids solution; however, one may start with hop extract of any type or variety. The hop extract was placed in a volume of water calculated to produce an aqueous alpha-acids solution, which had an alpha-acids concentration of 3-20% by HPLC. An alpha acid concentration of less than 8% was optimum. At this concentration, beta acid solubility in the aqueous phase was lowered. The temperature was raised to 50-70° C., and the pH was adjusted to 6-8, with constant mixing. A pH of 7-8 was optimum. The extract solution was then allowed to sit for at least 45 minutes. The resinous fraction containing beta-acids, oils and waxes was set aside, while the aqueous alpha-acids solution was decanted. The temperature was raised to 60° C. and the pH was raised to 7-9. The solution was analyzed by HPLC.

If the alpha-acids concentration was 10% or greater, water was added to bring the concentration to 10%. The solution was cooled to 1-19° C., and filtered or decanted.

If the alpha-acids concentration was less than 10%, the aqueous solution was acidified (H₂SO₄ or H₃PO₄ were satisfactory) at 60° C. to bring the alpha-acids out of solution. The alpha-acids were washed with fresh 60° C. water and allowed to sit for a minimum of 45 minutes. The water was discarded, and a calculated volume of 60° C. fresh water was added. The volume was calculated to produce a 10% alpha acid concentration by HPLC, also taking into account the volume of caustic necessary for pH adjustment. The alpha-acids solution was heated to 60° C., and the pH was raised to 7-9 with KOH solution. The aqueous solution was allowed to cool to 1-19° C., and filtered or decanted.

Example

800 g of supercritical CO₂ Nugget extract was added to 2700 mL of deionized water, and the temperature was increased, with constant mixing, to 60° C. Approximately 300 mL of 20% KOH was added to bring the pH up to 7.7. The solution was allowed to sit overnight. The resinous fraction containing beta-acids, oils and waxes was set aside, while the aqueous alpha-acids solution was decanted and cooled overnight to 7° C. The aqueous solution was then filtered, while cold, to remove any crystallized beta fraction, and brought back to 60° C. 20% H₂SO₄ was added with continuous stirring until the pH was 2.5. The resinous alpha-acids were separated and washed with fresh 60° C. deionized water. The alpha-acids were added to 2000 mL deionized water and brought to 60° C. Approximately 300 mL of 20% KOH was added to bring the pH up to 8.0, and the solution was analyzed by HPLC. Deionized water and 20% KOH were added to bring the concentration and pH up to 10% and 8.0, respectively. The solution was cooled to 5° C. overnight, and filtered.

10% alpha-acids solution is relatively easy to make (see above example) and is a clear solution with no precipitated material. Like the beta acids formulation, it is similar in color, clarity, and consistency to weak iced tea. The stability is not robust and a change in temperature can cause cloudiness to appear.

Dilution of 10% alpha-acids solution with tap water or well water results in the formation of a stable aqueous emulsion which has the appearance of milk and does not exhibit any separation even during days of storage. It was very stable even down to a dilution of 1:16, and no precipitate formed. Also, as the solution was diluted with water, only a minor change in the pH occurred. It dropped by about 0.5 pH units, certainly not enough to be the cause of the precipitation. No difference was observed when 0.4% Ninol emulsifier was added.

### Method of Application

The above emulsions were sprayed on plants according to the following procedure:

The above concentrated formulations were diluted with tap water to the desired concentration and the diluted portion agitated by shaking prior to spray application. Application of formulations to hop leaves in the laboratory was accomplished by a hand-held and manually operated bottle sprayer of 500 ml volume, with finger lever action and nozzle adjusted to the finest droplet size.

Application of each formulation consisted of two pulls of the sprayer lever with the nozzle 12 inches from the leaf surface. Each double pull of the lever applied approximately 2 milliliters of liquid to an area of approximately one square foot. The spray pattern did not provide droplet density sufficient to cover 100% of the leaf area, but droplets were close enough to each other to cover about 50% of the leaf area. Treated hop leaves were placed inside plastic bags at approximately 22 degrees centigrade. Each treatment consisted of 4 hop leaves.

Results

Tests were made on the two-spotted spider mite pest (Tetranychus urticae), on the beneficial predator mite (Galendromus occidentalis), and on the green peach aphid (Myzus persicae). Mortality was determined after 24 hours for pest mites, 48 hours for beneficial mites and 72 hours for aphids.

A 1:16 dilution of the original 10% concentrations resulted in an applied concentration of 0.625% for each formulation described above. At this concentration and under the described conditions, all three formulations produced 100% mortality of the treated pest mites within 24 hours of application, while the mortality of the beneficial mites was much less at about 25% after 48 hours

Concentrations of 10% produced the immediate death of about 30% of the aphids present for each formulation. Greater dilutions produced fewer immediate mortalities.

The invention described above is not to be limited by the above examples. It is to be limited only by the following claims, which are to be interpreted according to established doctrines of claim interpretation. The terms “hop acids,” “solution,” and “emulsion” are to be interpreted as used above and as they are understood in the hop industry.

What is claimed is:

1. A pesticide comprising hop acids emulsified in an aqueous agent.

2. The pesticide of claim 1, wherein the hop acids comprise beta acids.

3. The pesticide of claim 1, wherein the hop acids comprise alpha acids.

4. The pesticide of claim 1, wherein the hop acids comprise a beta fraction.

5. A pesticide comprising a solution of alpha acids diluted into an aqueous emulsion.

6. A pesticide comprising a solution of beta acids diluted into an aqueous emulsion.

7. A pesticide comprising an aqueous emulsion of a beta fraction of hop acids.
